(19) United States
(12) Patent Application Publication
(10) Pub. No.: US 2010/0225845 A1
(43) Pub. Date: Sep. 9, 2010

(54) Protection framework for liquid crystal display

(75) Inventor: Chang-Chih Liu, Taipei (TW)

Correspondence Address: BACON & THOMAS, PLLC, 625 SLATERS LANE, FOURTH FLOOR, ALEXANDRIA, VA, 22314-1176, US

(73) Assignee: Grandtec Electronic Corporation, Chung Ho City (TW)

(21) Appl. No.: 12/656,039

(22) Filed: Jan. 14, 2010

(30) Foreign Application Priority Data
Mar. 3, 2009 (TW) 098203106

(51) Int. Cl. G02F 1/1333

(52) U.S. Cl. 349/58

(57) ABSTRACT

The present invention provides a protection framework for liquid crystal display. It is composed of an upper, a lower, a right and a left frames, and each of the length of four frames is respectively matched with the length of each side edge of liquid crystal display. The four frames are engaged together with four connecting members each provided between the adjacent frames thereby forming an integral framework for LCD screen. Since the length of each frame can be modified to match the variously sized LCD screen so as to save preparation of a lot of different molds and jigs for fabrication of frameworks as that is necessary in conventional technique, the production cost can be greatly reduced.

### BACKGROUND OF THE INVENTION

1. Field of the Invention

The present invention relates to a protection framework for liquid crystal display (LCD), in particular, to a protection framework for LCD that can be suitable for protecting LCD of different dimensions.

2. Description of Prior Art

Conventionally, the protection framework is integrally formed in one piece so that the LCDs of different dimensions have to select particular one with the corresponding size among various frameworks for use. In such a case the manufacturer must always prepare a variety of frameworks for the user to select that leads to increase the extra fabrication cost by preparing a lot of different molds and jigs thereby being impossible to bring down the market price to benefit the user.

### SUMMARY OF THE INVENTION

In view of the foregoing situation, and in a bid to rectify the defects noticeable on the prior art, the inventor of the present invention herein conducted intensive research based on many years of experience gained through professional engagement in the manufacturing of the related products of the protection framework for LCD, with continual experimentation and improvement finally culminating in the development of a novel protection framework for LCD to attain the aim of getting rid of the dejects inherent to the prior art.

Accordingly, it is an object of the present invention to provide a protection framework for LCD that can be suitable for protecting LCDs of different dimensions so as to curtail the production cost in a large scale.

To achieve the above object, the protection framework for LCD provided by the present invention is composed of an upper, a lower, a right and a left frames. The length of each of the frames can be appropriately modified to match the length of the corresponding edge of the LCD screen. Between the adjacent ones of upper, lower, right and left frames there is provided with a connecting member to engage the adjacent frames together so as to form an integrated framework for LCD. Each frame has at least a transversely drilled via hole, and a longitudinal installation groove is formed along its lengthwise direction. Each connecting member is provided with a connector in X direction and another connector in Y direction wherein each connector has two attachment blades so as to be plugged into the corresponding via holes formed on the frames thereby engaging all the upper, lower, right and left frames together to form a protection framework. With such a structure, the length of frames can be modified to match the LCD screens of various sizes so as to save preparation of a lot of different molds and jigs for fabrication of frameworks thereby greatly reducing the production cost.

Other objects and purposes of the invention will be apparent to persons acquainted with apparatus of the general type upon reading the following description and inspection of the following accompanying drawings.

### BRIEF DESCRIPTION OF THE DRAWINGS

FIG. 1 is an exploded schematic drawing of the protection framework for LCD according to the present invention.

FIG. 2 is an assembly drawing of the protection framework for LCD according to the present invention.

### DETAILED DESCRIPTION OF THE PREFERRED EMBODIMENTS

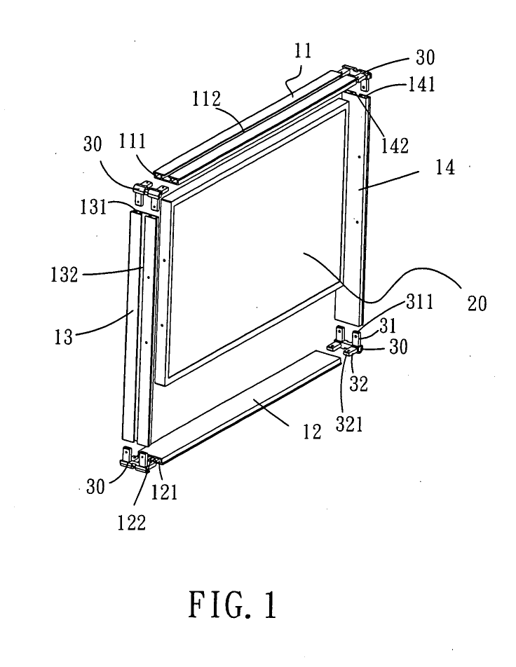

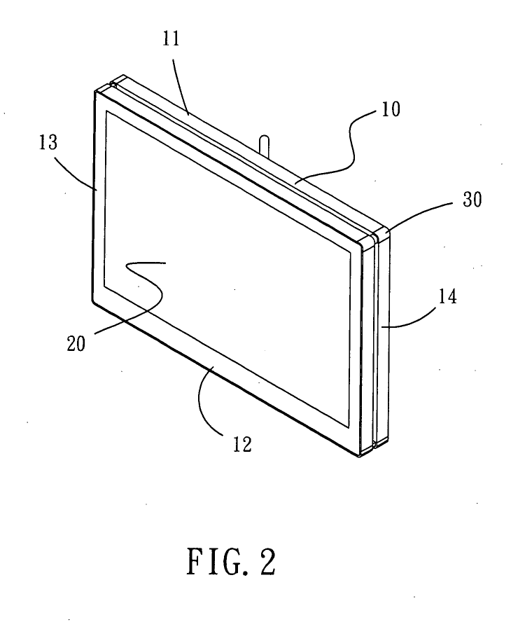

Referring to FIGS. 1 and 2, the protection framework 10 for LCD provided by the present invention is composed of an upper, a lower, a right and a left frames respectively given the numerals of 11, 12, 14 and 13 in order, each of them having a length appropriately modifiable to match the length of the edge of a LCD screen 20 to be associated. Between the adjacent ones of upper, lower, right and left frames 11, 12, 14 and 13 there is provided with a connecting member 30 to engage the adjacent frames together so as to form an integrated framework 10 for LCD screen shown in FIG. 2.

Each of the frames 11, 12, 14 and 13 has at least a transversely drilled via holes 111, 121, 141, and 131, and a longitudinal installation grooves 112, 122, 142 and 132 formed along the lengthwise direction of the corresponding frames 11, 12, 14 and 13. Each connecting member 30 is provided with a connector 31 in X direction and another connector 32 in Y direction whereas each of the connectors 31 and 32 has two attachment blades 311, 321 so as to be plugged into the corresponding via holes 111, 121, 141 and 131 whose opening being facing to the end face of the frames 11, 12, 14 and 13 thereby engaging all the upper, lower, right and left frames 11,12, 14 and 13 together to form the framework 10 surrounding the circumference of the LCD screen.

With this structure, the length of each frame can be modified to match the variously size LCD screens 20 so as to save preparation of a lot of different molds and jigs for fabrication of frameworks as that is necessary in the conventional technique thereby greatly reducing the production cost.

Each of the frames 11, 12, 14 and 13, and the connecting member 30 are made of rubber, metal or plastic material.

A hanger (not shown) can be provided to the installation groove 112 formed on the upper frame 11 in order to suspend the LCD screen 20 in the air. Alternatively the installation grooves 112, 122, 142 and 132 of the frames 11, 12, 14 and 13 can be stably mounted to or on an object (such as the wall surface or cabinet) so as to securely hold the screen 20 there.

In all present invention is a high level technical creation and by no means, simply utilizes conventional technology or knowledge known, or can easily be made by persons skill in the art, prior to the application for patent. The invention has neither been published or put to public use, nor displayed in an exhibition thus the present invention is entitled to a patent.

It is apparent to a person skill in the art that the basic idea of the invention can be implemented in many different ways. The invention and its embodiment are thus not restricted to the example described above, but may vary with the scope of the claims.

What is claimed is:

1. A protection framework for LCD composed of:
an upper, a lower, a right and a left frames each of them having a length appropriately modifiable to match the length of the corresponding edge of a LCD screen to be associated;
Four connecting members each provided between adjacent frames to engage said adjacent frame together so as to form an integrated framework for protecting said LCD;
at least a transversely drilled via hole provided for each of said four frames; and
four longitudinal installation grooves each formed along the lengthwise direction of each frame; and
wherein each of said four connecting members is provided with a connector in X direction and another connector in Y direction whereas each of said connectors further has a pair of attachment blades so as to be plugged into the corresponding via holes whose opening being facing to the end face of their frames thereby engaging all four frames together to form said framework surrounding the circumference of said LCD screen.

2. The protection framework as claimed in claim 1, wherein said frames are made of rubber, metal or plastic material.

3. The protection frame work as claimed in claim 1, wherein said connecting members are made of rubber, metal or plastic material.
